(19) United States
(12) Patent Application Publication
(10) Pub. No.: US 2005/0161308 A1
(43) Pub. Date: Jul. 28, 2005

(54) Vehicle steering wheel

(75) Inventor: Ralph Frisch, Mombris (DE)

Correspondence Address: TAROLLI, SUNDHEIM, COVELL, & TUMMINO L.L.P., 111 LEADER BLDG., 526 SUPERIOR AVENUE, CLEVELAND, OH, 44114-1400, US

(73) Assignee: TRW Automotive Safety Systems GmbH

(21) Appl. No.: 11/039,731

(22) Filed: Jan. 19, 2005

(30) Foreign Application Priority Data
Jan. 22, 2004 (DE) 20 2004 000 953.6

(51) Int. Cl. H01H 9/00

(52) U.S. Cl. 200/61.54

(57) ABSTRACT

A vehicle steering wheel comprises a steering wheel skeleton, a longitudinal axis, at least two components movable relative to each other, and a horn contact switch, which has two electrical contact elements which are brought in contact with each other by means of a relative movement of the two components to each other for a horn actuation. The electrical contact elements are contact wires.

### TECHNICAL FIELD

The invention relates to a vehicle steering wheel.

### BACKGROUND OF THE INVENTION

A vehicle steering wheel known from the German Utility Model 200 17 527 comprises a gas bag module connected with the steering wheel skeleton and mounted so that it is displaceable in the direction of the longitudinal axis for actuation of the horn. The electric contact elements comprise an electrically conductive detent hook projecting on the gas bag module on the rear side, which on actuation of the horn is brought in contact with a likewise conductive spring wire. In addition, it is known to construct the contact elements as metallic punched parts which are arranged on movable parts of the vehicle steering wheel and which come into contact with each other on actuation of the horn.

The existing solutions from the prior art always require a particular overall height and frequently also particular parts which are to be manufactured by punching and/or bending, the manufacture of which is cost-intensive and the installation of which is complicated.

Proceeding form these disadvantages, the invention is based on the problem of avoiding these disadvantages at least partially and providing a particularly favourably priced horn contact switch.

### BRIEF SUMMARY OF THE INVENTION

According to the invention, this problem is solved by a vehicle steering wheel comprising a steering wheel skeleton, a longitudinal axis, at least two components movable relative to each other, and a horn contact switch, which has two electrical contact elements which are brought in contact with each other by means of a relative movement of the two components to each other for a horn actuation. The electrical contact elements are contact wires.

Thereby, particular punched parts or special parts are no longer necessary. Rather, only two wires which are provided in any case have to be partially insulated, which are brought into contact with each other through the relative movement of two components of the vehicle steering wheel. The wires forming horn contacts are part of the known horn current circuit. The horn contacts and the horn current circuit are designed so that with a contact of the wires, the horn sounds.

The two contact wires, preferably intersecting, viewed in the longitudinal axis, can be provided, uncoupled from each other, on two components, for example one on the underside of the intermediate plate of a gas bag module and the other on the corresponding site on the upper side of the hub of the skeleton.

The horn contact switch according to the invention is particularly compact and simple to install when the two contact wires are provided coupled to a common component. For example, the contact wires can be arranged running parallel to each other in a recess, a first contact wire being spaced apart from the second contact wire, which is provided with a U-shaped curvature. For actuation of the horn, the elastic second contact wire is acted upon by force in the curved region and twisted, and also pressed onto the first contact wire, in order to close the horn current circuit After the horn actuation, the second contact wire moves independently into the unactuated initial position.

Finally, the contact wires could be arranged in a common switch element with its own housing. This switch element, provided with plugs, can be fastened on installation simply onto the corresponding site, a corresponding coupling ensuring the necessary fixing of the plug, so that no further fixing means are necessary.

The common arrangement of the two contact wires to a component involves the further advantage that the elastic contact wire can undertake the function of the restoring spring inside the vehicle steering wheel. Through corresponding dimensioning of the elastic contact wire, it is therefore no longer necessary to provide additional restoring springs for the gas bag module alongside the electric contact element or, if no gas bag is to be provided, for the component (e.g. steering wheel hub cap) which is to be moved by the driver. Thereby, a particularly compact and low overall height can be realized.

In order to ensure a good contact between the contact wires on actuation of the horn, on one of the components carrying out the relative movement an actuating element can be provided, which presses one contact wire onto the other on actuation of the horn. This actuating element can be constructed either as an additional component which is to be installed or can be formed in one piece on a component, e.g. by injecting on a plastic part. This is particularly advantageous, because a plastic element is electrically insulating and does not have an effect on the mode of operation of the horn contact.

### BRIEF DESCRIPTION OF THE DRAWINGS

FIG. 1 shows a diagrammatic cross-sectional view through a first embodiment of the vehicle steering wheel according to the invention;

FIG. 2a shows an enlarged view of the detail II of the vehicle steering wheel according to FIG. 1 with the horn not actuated;

FIG. 2b shows an enlarged view of the detail II of the vehicle steering wheel according to FIG. 1 with the horn actuated;

FIG. 3 shows a diagrammatic cross-sectional view through a second embodiment of the vehicle steering wheel according to the invention; and

FIG. 4 shows an enlarged perspective view of the detail IV of FIG. 3.

### DETAILED DESCRIPTION OF PREFERRED EMBODIMENTS

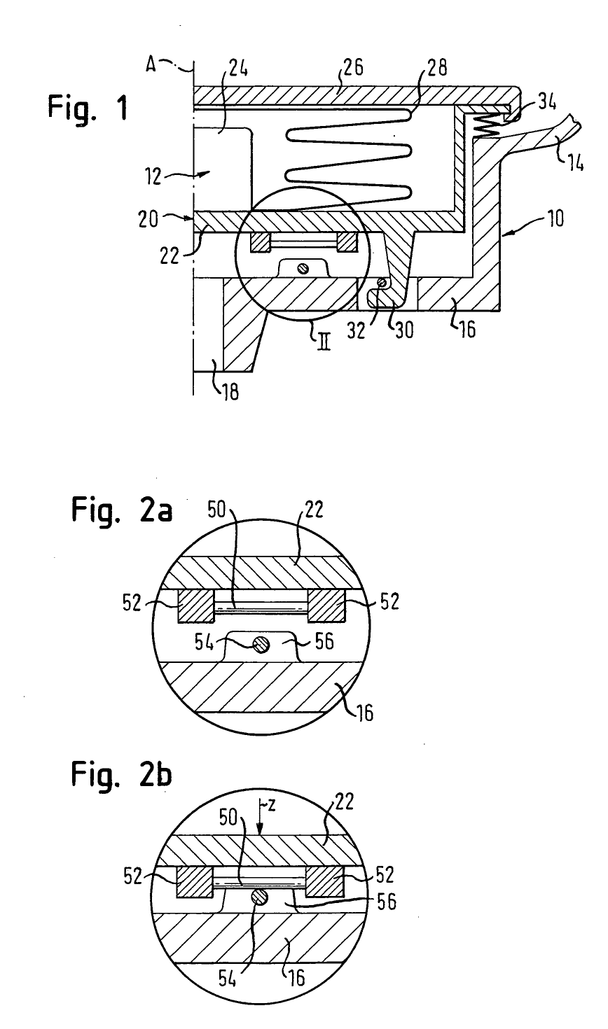

According to FIG. 1, a vehicle steering wheel has a steering wheel skeleton 10 and a gas bag module 12. The longitudinal axis A of the steering wheel is represented by a dot-and-dash line. The steering wheel skeleton 10 has a steering wheel rim, surrounded by foam, not illustrated, which is connected by means of spokes 14 with a cup-shaped steering wheel hub 16. In the region of the longitudinal axis A of the vehicle steering wheel, the hub 16 has a mounting opening 18 to receive a steering column.

The gas bag module 12, constructed as a “floating horn” is illustrated by way of example and has a cup-shaped module housing 20 with a base 22, which at the same time forms the carrier for a gas generator 24. The module housing 20 is closed towards the vehicle interior with a covering 26, which covers a gas bag 28 folded inside the module housing 22.

On the underside of the base 22, several detent hooks 30, constructed in a known manner, are formed for fastening the module housing 20 on the hub 16. The fastening takes place by means of arresting means which are secured to the skeleton. The arresting means consist here of components which are securely mounted in the skeleton but displaceable laterally by a certain amount (e.g. wires 32), which lock the detent hooks 30 in the installed position. This connection is designed so that a movement of the module housing 22 is made possible in the direction of the longitudinal axis A inside the steering wheel, without the detent connection 30, 32 being released.

Between the module housing 20 and the skeleton 10, compression springs 34 are arranged in a manner known per se. These compression springs 34 exert a restoring force onto the module housing 20 acting contrary to the actuating force for the horn. They are also designated as restoring springs.

On the underside of the base 22 of the module housing 20, a first contact wire 50 partially extends between two cross-pieces 52 on the base 22 of the module housing 20. The cross-pieces 52 can be of plastic or metal. The contact wire 50 can be insulated (in metal cross-pieces 52, it is compulsorily insulated); between the cross-pieces 52 it is in every case non-insulated. This first contact wire 50 represents the first of two contact wires of the horn contact switch. The second contact wire 54 of the horn contact switch extends running in the direction of viewing of FIGS. 1 and 2b and thereby transversely to the longitudinal axis of the first contact wire 50 over a particular section on the upper side of the hub 16 between two cross-pieces 56, which are provided for example in the foam surrounding the skeleton. The second contact wire 54 is also not insulated in the section between the cross-pieces 56. The arrangement of the contact wires 50, 54 is constructed so that the first contact wire 50 in the installed position crosses the second contact wire 54 viewed in the direction of the longitudinal axis A, but is spaced apart from it. On actuation of the horn, the first contact wire 50 is pressed onto the second contact wire 54; this closes the horn contact switch. At least one of the two contact wires 50, 54 is mounted so as to be elastically flexible e.g. like a bending beam, so that it performs a stroke on actuation of the horn. The restoring movement of the module 10 can support the stroking contact wire 50, 54.

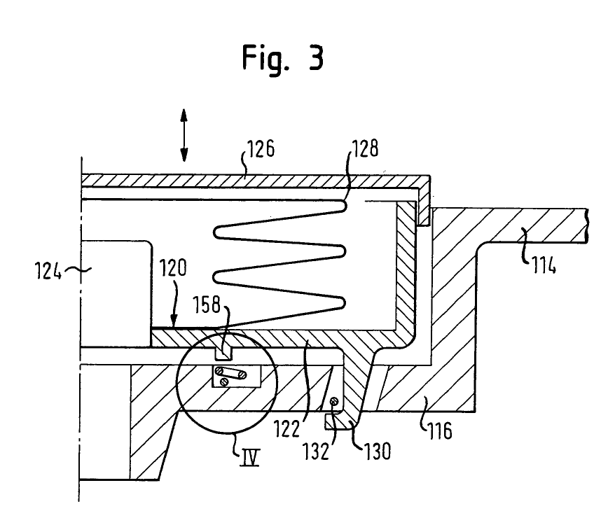

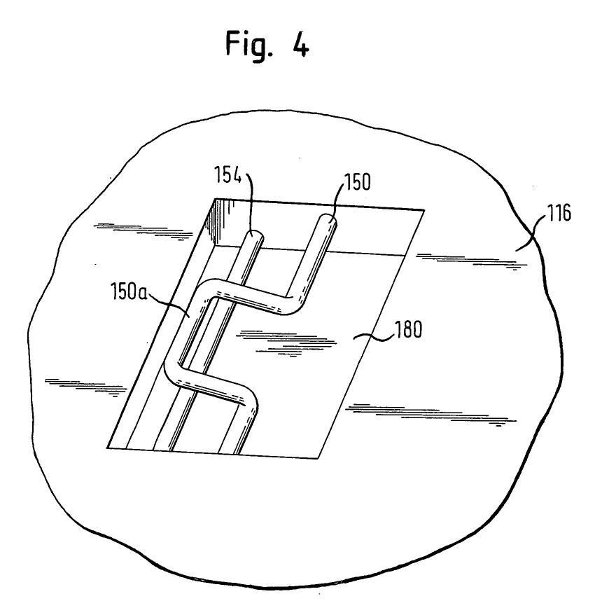

The second embodiment, illustrated in FIGS. 3 and 4, differs from the one previously described in that the two intersecting contact wires of the horn contact switch are provided coupled to a common component of the vehicle steering wheel. The corresponding components of the second embodiment in FIGS. 1 to 2b are marked by reference numbers increased by 100. The essential difference in this embodiment lies in that the intersecting contact wires 150 and 154 are not uncoupled, as in the first embodiment, but rather are arranged coupled to the steering wheel hub 116, i.e. to the same component. For this purpose, in the upper side of the steering wheel hub 116 a trough-shaped recess 180 is provided, in which the insulated contact wires 150 and 154, running through the skeleton 10, extend approximately parallel to each other. In the region of the recess 180, the contact wires 150, 154 are not insulated. The first contact wire 150 is arranged staggered slightly upwards and to the side from the second contact wire 154 in the recess 180. It has, in addition, a U-shaped or arc-shaped curvature 150a which crosses the second contact wire 154 in the initial position in the direction of longitudinal axis A, but spaced apart from it. The first contact wire 150 is constructed as a torsion spring and has a sufficient elastic force in order to undertake the function of the restoring- or compression springs 34. With the horn actuation, the module housing 120 presses with an actuating element protruding on the rear side in the form of a projection 158 against the first contact wire 150 in the region of the curvature 150a and twists it against the elastic force of the first contact wire 150, until the contact wires 150, 154 touch each other, and thus closes the horn contact switch.

Alternatively to this, the contact wires 150, 154 can of course also be housed in the surrounding foam of the skeleton 10, which does not have to be additionally illustrated.

Spring bronze, for example, can be selected as material for the contact wires 50, 54, 150, 154.

Preferably, of course, several horn contact switches are provided between module and skeleton 10, 110, which all together are formed only by the contact wires 50, 54, 150, 154, which run in a loop shape between module and skeleton.

Owing to the coupled arrangement of the contact wires 150, 154 in the recess 180, in particular in the second embodiment the vehicle steering wheel has a flatter overall height than the prior art. In addition, in this embodiment, no additional compression springs are necessary for restoring the horn; the horn contact therefore undertakes the restoring function. All the embodiments have in common the fact that few separate components are required, and the contact wires are part of the conductors carrying signal current which are in any case provided. It is to be clearly understood that the construction according to the invention is not limited those vehicle steering wheels which have a gas bag module.

1. A vehicle steering wheel with a steering wheel skeleton (10, 110), a longitudinal axis (A), at least two components movable relative to each other, and a horn contact switch, which has two electrical contact elements which are brought in contact with each other by means of a relative movement of said two components to each other for a horn actuation, wherein said electrical contact elements are contact wires (50, 54; 150, 154).

2. The vehicle steering wheel according to claim 1, wherein said contact wires (50, 54; 150, 154) are provided uncoupled from each other on said components, which perform a relative movement to each other when actuating said horn.

3. The vehicle steering wheel according to claim 1, wherein both contact wires (150, 154) are provided on a common component at a distance from each other, at least one of said contact wires (150) being moved by the action of force from said exterior in said direction of said other when actuating said horn.

4. The vehicle steering wheel according to claim 1, wherein at least one of said contact wires (50; 154) is constructed so as to be flexible.

5. The vehicle steering wheel according to claim 1, wherein one of said components which components come closer on actuation of said horn comprises a gas bag module (12, 112) mounted flexibly on said steering wheel skeleton (10, 110) and displaceably in said direction of longitudinal axis (A), and that said horn contact switch is arranged between said gas bag module (12, 112) and said steering wheel skeleton (10, 110).

6. The vehicle steering wheel according to claim 4, further comprising at least one restoring spring acting between said components coming closer on actuation of said horn, said flexible contact wire (154) serving as restoring spring.

7. The vehicle steering wheel according to claim 4, wherein an actuating element which presses one contact wire (154) against said other when actuating said horn is provided.

8. The vehicle steering wheel according to claim 7, wherein said actuating element is constructed as a projection (158) on said rear side oh said component moved by said driver for actuation of said horn.

9. The vehicle steering wheel according to claim 1, wherein said contact wires (50, 54; 150, 154) intersect each other in said direction of said longitudinal axis.

10. The vehicle steering wheel according to claim 1, wherein said contact wires (50, 54; 150, 154) are arranged running substantially parallel at a distance from each other and wherein said contact wire (150) moved on actuation of said horn has an arc-shaped curvature (150a) and touches said other contact wire (154) in said region of said curvature (150a).
